(19) United States
(12) Patent Application Publication
(10) Pub. No.: US 2022/0174787 A1
(43) Pub. Date: Jun. 2, 2022

(54) HEATING DEVICE FOR AN EXHAUST SYSTEM

(71) Applicant: Faurecia Emissions Control Technologies, Gemany GmbH, Augsburg (DE)

(72) Inventors: Matthias MALLON, Augsburg (DE); Manuel BERNHARD, Augsburg (DE); Rita FEHLE, Augsburg (DE); Jörg VEITTINGER, Augsburg (DE); David SAURAT, Augsburg (DE); Anton BERCHTOLD, Augsburg (DE)

(21) Appl. No.: 17/536,594

(22) Filed: Nov. 29, 2021

(30) Foreign Application Priority Data
Nov. 30, 2020 (DE) 10 2020 131 726.3

(51) Int. Cl. H05B 3/06

(52) U.S. Cl. CPC H05B 3/06; H05B 2203/016; H05B 2203/022

(57) ABSTRACT

A heating device for an exhaust system has an electrically conductive heating component through which exhaust gas to be treated can flow and which is formed by one or more current-carrying lines forming a current path in the form of a resistance heating element. In addition, the heating device has at least one stabilization part which extends over at least a portion of the heating component, is arranged so as to be offset in the flow direction in relation to the heating component, and is mechanically coupled to the heating component in order to stabilize the latter in the flow direction.

### CROSS-REFERENCE TO RELATED APPLICATIONS

This application is a U.S. non-provisional application claiming the benefit of German Application No. 10 2020 131 726.3, filed on Nov. 30, 2020, which is incorporated herein by reference in its entirety.

### TECHNICAL FIELD

The disclosure relates to a heating device for an exhaust system.

### BACKGROUND

Exhaust systems of internal combustion engines usually include catalytic converters to reduce emissions.

In order for catalytic oxidation to proceed in an optimum manner immediately after a cold start, it is known to provide heating devices that heat the catalytic converter to a reaction temperature.

Furthermore, a heating device through which exhaust gas flows may be provided, which is arranged upstream of the catalytic converter and is configured to heat the exhaust gas before it flows through the catalytic converter.

It is already known here to provide heating grids or heating wires for heating.

However, the installation and mounting of such heating devices in exhaust systems is generally complicated. In addition, such heating devices are subjected to high loads during operation due to large temperature fluctuations and vibrations, which has an adverse effect on the service life of the heating device.

### SUMMARY

The disclosure provides a heating device for an exhaust system which is particularly simple to manufacture and install and which can withstand the stresses existing in the exhaust system.

More particularly, the disclosure provides a heating device for an exhaust system, in particular of a motor vehicle, having an electrically conductive heating component which is coupled to at least one electrode and is attached at its outer circumference to a duct wall-side holder and is oriented transversely (i.e. orthogonally or obliquely) to an exhaust gas stream. The exhaust gas to be treated can flow through the heating component in an axial flow direction in an inner region delimited by the holder, and the heating component includes an upstream-oriented front end face and a downstream-oriented rear end face. The heating component is formed by one or more current-carrying lines forming a current path in the form of a resistance heating element between the at least one electrode and a further electrically conductive part, in particular a further electrode, to which the heating component is coupled. Furthermore, the heating device has at least one stabilization part which extends inwardly of the holder over at least a portion of the inner region of the heating component. The stabilization part is arranged so as to be offset in relation to the heating component in the flow direction and is mechanically coupled in the inner region to the heating component in order to additionally stabilize the latter in the flow direction.

In the context of the disclosure, axial direction means an axial direction relating to the heating device and/or the heating component and substantially parallel to a main flow direction of the exhaust gas to be treated. Accordingly, a central axis (normal) of the heating device and/or the heating component extending in the axial direction is substantially parallel to the main flow direction.

In the context of the disclosure, a transverse direction means a direction that is orthogonal or oblique (e.g., at an angle of up to 45°) to the axial direction. The transverse direction thus includes a radial direction.

The core of the disclosure therefore is an electrically conductive heating component that is very simple to manufacture, having a current path which, when a current is applied to the at least one electrode and the further electrically conductive part, acts as a resistance heating element and in this way heats the heating component and consequently the exhaust gas to be treated that flows through the heating component.

To avoid electrical bypasses or electrical short circuits, the at least one stabilization part may be electrically insulating, at least in the region of the surfaces in contact with the heating component.

To this end, the at least one stabilization part may include an electrically insulating coating, for example a ceramic coating.

Alternatively or additionally, the at least one stabilization part may be made of an electrically insulating material, in particular constitute a dielectric.

Alternatively or additionally, the heating component and the stabilization part may be electrically insulated from each other in the region in which they are mechanically coupled to each other. In this way, the electrical insulation can be limited to the coupling area, as a result of which the use of insulating material can be significantly reduced. In addition, this allows the stabilization part to be assigned a different function instead of an insulating function, e.g. as a further heating element or as a catalyst.

One aspect provides that at least one coupling part is provided, in particular a plurality of coupling parts are provided that are laterally spaced apart from each other, which couple(s) the heating component and the stabilization part mechanically to each other in the inner region. The coupling part can be used to simply keep the heating component and the stabilization part at a distance and in this way produce a simple electrical insulation. To this end, it is sufficient if the at least one coupling part is formed to be electrically insulating.

The heating component and/or the stabilization part may be fastened to the coupling part in an electrically insulating manner, and/or the heating component and/or the stabilization part may be clamped between parts of the coupling part in an electrically insulating manner.

For example, the at least one coupling part is formed as a spacer, merely resting against the opposing end faces of the heating component and of the stabilization part, and is glued, welded, soldered or fastened thereto by some other substance-to-substance bonding method.

The heating component may be designed in a variety of ways. For example, the heating component may be a heating grid or a heating wire or a foamed part. All of these forms of configuring the heating component have in common that the one or more current-carrying lines constitute a current path as a resistance heating element between the at least one electrode and a further electrically conductive part to which the heating component is coupled.

One aspect provides that the heating component and/or the stabilization part is/are a foamed part.

Preferably, the heating component is a first foamed part which has at least one recess starting from the outer circumference. The at least one recess here extends through the foamed part from the front end face to the rear end face in the axial direction, so that sections of the foamed part are produced by the recess which continue into each other, forming a current path as a resistance heating element between the at least one electrode and a further electrically conductive part, in particular a further electrode, to which the first foamed part is coupled. Furthermore, the stabilization part is a second foamed part.

However, due to the recesses, the inherent stiffness of the foamed part is reduced, which is unfavorable. By coupling the first foamed part to at least one stabilization part, a relative movement, in particular an axial and/or radial relative movement, of the sections can be prevented, which is caused, for example, by the gas flow or by vehicle or engine vibrations. This allows the stiffness, in particular the axial and/or radial stiffness, of the heating device to be markedly increased. The stabilization part thus serves as a support. The first foamed part is axially and/or radially stabilized or supported in that the stabilization part is held over a cross-sectional area with the first foamed part.

It may be provided that the at least one stabilization part mainly stabilizes the sections relative to each other. A holding or support function, in particular in the axial direction, then plays only a secondary role or is not intended.

Alternatively or additionally, the at least one stabilization part may contribute indirectly or directly to a mounting or support, in particular an axial mounting or support. For example, the at least one stabilization part is fastened to the gas duct wall by a carrying device and, in a way, contributes to carrying the foamed part, in addition to stabilizing the foamed part.

Within the scope of this disclosure, a distinction between the term “stabilization” and the term “holder/support” is of major importance. Stabilization refers to an increase in the stiffness of the heating device. The stabilization of the first foamed part is implemented by coupling it to the stabilization part, which reduces the load on the heating device as caused by vibration excitations as well as by other mechanical loads, such as gas pulsations, gas flow-through and/or temperature expansions. The aim is to support the heater tracks (sections) that form the current path to the effect that the heating device permanently withstands the typical loads in the exhaust gas flow. In contrast, the holder or support describes an attachment of the heating device in the gas line or an axial resting of the heating device against a part fastened to the gas line.

To ensure electrical conductivity and, consequently, heating of the foamed part by an electric current flow, the foamed part may be coated with or be comprised of an electrically conductive material, e.g., be a metal foam.

Optionally, the foamed part (i.e. the first foamed part and/or the stabilization part) may additionally comprise a catalytic material. In this way, a catalytic function can also be obtained in addition to the heating function. In this case, the foamed part also constitutes an electrically heated catalyst (EHC).

The coupling part that mechanically couples the first foamed part and the second foamed part to each other in the inner region may extend through the recess of the first foamed part to the adjacent second foamed part and be fastened thereto. In contrast to a pure spacer, which is merely arranged between the end faces of the foamed parts, a coupling part of this type has a larger area of contact with the associated foamed part, as a result of which an improved fastening of the coupling part in the foamed part and, if applicable, a higher stabilization of the foamed part can be achieved.

In particular, the coupling part includes a pin which extends through at least one foamed part and is surrounded by an electrical insulation on the outside. Since the cross-section of a pin is relatively small in comparison to the flow cross-section, the gas flow is hardly affected.

For example, the coupling part is a metal pin that is surrounded by a ceramic coating on the outside.

Alternatively or additionally, the coupling part may also be made of an insulating material, for example of ceramics.

In particular, the insulation is a sleeve surrounding the pin or a ring surrounding the pin, the sleeve or the ring contacting the foamed part and holding it away from the pin, in particular wherein the sleeve and/or the ring is a part that is separate from the pin. Such insulation is simple to manufacture and can be easily installed in the heating device.

According to a further aspect, the sleeve, biased in the longitudinal direction of the pin, presses against that foamed part through which the pin extends. This allows, for example, any manufacturing-related gaps or distances between the coupling part and the foamed part to be compensated, as a result of which movements and attendant noises can be prevented. Furthermore, a defined clamping force is applied to the foamed part.

According to one embodiment, the at least one recess extends between the sections in a straight line and/or in a curved manner in an axial view, in particular wherein the current path extends in a spiral shape or a meandering shape. The at least one recess specifies a path of the electric current through the foamed part. The current path defined in this way is significantly extended in comparison to the current path of a foamed part without recesses, which results in a higher heating power and thus in a uniform heating of the foamed part and, consequently, of the exhaust gas to be treated.

A further embodiment provides that the second foamed part has the same geometry as the first foamed part and, viewed in the axial direction, is installed to be offset by an angle in the circumferential direction in relation to the first foamed part. As a result, the recesses of the two foamed parts are not completely superimposed, and preferably they overlap each other only in sections, with the coupling part preferably being provided in an overlapping area of the recesses. Owing to the identical configuration of the two foamed parts, a cost-effective production of the heating device can be ensured. Because of the arrangement of the coupling part in the overlapping area of the recesses of the two foamed parts, there is no need for any additional fastening holes to be provided in one or both of the foamed parts. Moreover, the staggered installation of the foamed parts already ensures a stabilization of the foamed parts, since the recess of one foamed part is largely overlapped by a section of the other foamed part. This reduces or avoids a relative movement of opposite sections of a foamed part in relation to each other.

For example, the second foamed part is a resistance heating element or a catalyst. By having a further resistance heating element in addition to the first foamed part, an even better heating of the gas to be treated can be achieved. A catalyst serving as a second foamed part ensures, in addition to the heating of the gas by the first foamed part, a catalytically assisted conversion by the second foamed part of combustion pollutants in the gas. The second foamed parts thus have a dual function, so that the employment of further parts which would otherwise have to take over one of the functions, can be reduced or even completely dispensed with.

Optionally, as a resistance heating element, the stabilization part may additionally comprise a catalytic material. In this way, a catalytic function can be obtained in addition to the heating function. In this case, the stabilization part also constitutes an electrically heated catalyst (EHC).

According to one aspect, a support frame may be attached to the outer circumference of the first foamed part. The second foamed part and/or a stabilization element may be fastened to the support frame, so that the two foamed parts together with the support frame may form a pre-assembled unit. Furthermore, the stabilization element can reduce or avoid uncontrolled deformation of the support frame and consequently of the first foamed part, in particular also of the second foamed part.

Optionally, the support frame has a plurality of parts coupled to one another, which rest against the end faces and between which the foamed part is clamped, the parts being electrically non-conductive at least in their respective region contacting the end faces so as to avoid short circuit currents.

In particular, the coupled parts extend along the outer circumference and clamp the foamed part in the region of the outer circumference.

As an alternative, there is a frame part on one end face and separate parts on the opposite end face, which are fixed with the frame part. The foamed part is clamped between the frame part and the separate parts. Here, the areas coming into contact with the end faces are electrically non-conductive.

Instead of or in addition to the second foamed part, according to a further disclosure an inherently stiff, deformable stabilization element may be provided as a stabilization part, which in an axial view extends transversely, and in particular in an S-shape, over at least a section of the inner region and is fastened to the first foamed part by the at least one coupling part and/or by a fastening device. This allows uncontrolled lateral deformations of the first and/or second foamed part to be reduced or avoided. Furthermore, a relative movement, in particular an axial relative movement, of the sections can be prevented, which is caused, for example, by the gas flow or by vehicle vibrations. This allows the stiffness, in particular the axial stiffness, of the heating device to be considerably increased. The stabilization element thus serves as a support part, which rests against the foamed part by a cross-sectional area, thereby stabilizing or supporting it axially.

In particular, the stabilization element extends from a region of the support frame transversely across the first foamed part to a substantially diametrically opposed region of the support frame. In this way, the support frame is radially supported, whereby the radial stiffness of the support frame and consequently of the heating device is increased.

### BRIEF DESCRIPTION OF THE DRAWINGS

The disclosure will be explained below with reference to various exemplary embodiments, which are shown in the accompanying drawings.

FIG. 1 schematically shows an exhaust system with a heating device according to the disclosure;

FIG. 2 schematically shows the heating device according to the disclosure as shown in FIG. 1;

FIG. 3 shows a top view in the main flow direction of a first embodiment of a foamed part of the heating device according to the disclosure as shown in FIGS. 1 and 2;

FIG. 4 shows a top view in the main flow direction of a second embodiment of the foamed part;

FIG. 5 shows a top view in the main flow direction of the heating device according to the disclosure in an embodiment with two electrically conducting foamed parts according to FIG. 4;

FIG. 6 shows a detail view of an area of the heating device according to the disclosure as shown in FIG. 5, in which the foamed parts are fastened to each other by a first coupling method;

FIG. 7 shows an axial section of an area of the heating device according to the disclosure as shown in FIGS. 1 and 2, in which the foamed parts are fastened to each other by a second coupling method, wherein, inter alia, a first variant of a coupling part is illustrated;

FIG. 8 shows an axial section of a second variant of the coupling part;

FIG. 9 shows an axial section of a third variant of the coupling part;

FIG. 10 shows an axial section of a fourth variant of the coupling part;

FIG. 11 shows an axial section of a fifth variant of the coupling part; and

FIG. 12 shows a perspective view of an alternative heating device according to the disclosure as shown in FIG. 7 without the second foamed part, but with a stabilization element.

### DETAILED DESCRIPTION

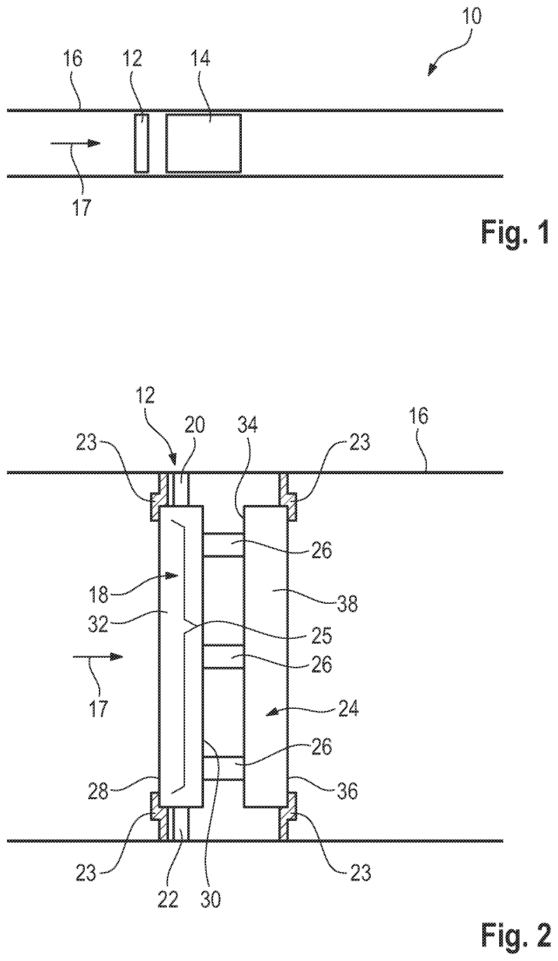

FIG. 1 schematically illustrates an exhaust system 10 comprising a heating device 12 and a catalytic converter 14.

The heating device 12 and the catalytic converter 14 are arranged within an exhaust gas-carrying pipe 16 of the exhaust system 10 such that exhaust gas flows through both the heating device 12 and the catalytic converter 14.

The main flow direction 17 (axial flow direction) of the exhaust gas is depicted in simplified form by an arrow.

The heating device 12 is arranged upstream of the catalytic converter 14 so that the heating device 12 can heat the exhaust gas before it flows through the catalytic converter 14. This improves catalytic oxidation, in particular immediately after a cold start, and emissions are reduced since the catalytic converter 14 is heated up quickly.

FIG. 1 illustrates the heating device 12 and the catalytic converter 14 separately from each other. This is to be understood only by way of example, since in one embodiment the catalytic converter 14 may be integrated in the heating device 12, as will be described in more detail further below.

FIG. 2 shows a first embodiment of the heating device 12 in more detail.

The heating device 12 comprises an electrically conductive heating component 18 which is electrically connected to diametrically opposed electrodes 20, 22 and is secured in the exhaust gas duct 16 by a duct wall-side holder 23. The heating component 18 extends transversely (i.e. orthogonally or obliquely) to the main flow direction 17.

In the present case, the further electrical component which is present in addition to one of the electrodes 20, 22 is thus formed by the other of the two electrodes 20, 22.

Furthermore, the heating device 12 includes a stabilization part 24 that extends over an inner region 25 (inward of the holder 23) of the heating component 18 and is attached to the heating component 18 via coupling parts 26 provided in the inner region 25.

The coupling parts 26 may be formed separately from the heating component 18 and the stabilization part 24 here, or may be integrally connected to the heating component 18 or the stabilization part 24.

In the embodiment shown here, the stabilization part 24 is arranged downstream of the heating component 18 at an axial distance in the direction of flow. This is to be understood merely as an example. Of course, the stabilization part 24 could also be provided upstream of the heating component 18.

The heating component 18 may have an electrically conductive coating or may be comprised of an electrically conductive material, e.g., metal foam.

Optionally, the heating component 18 may additionally comprise a catalytic material, for example be coated therewith, which gives the heating component 18 a catalytic function in addition to the heating function. A heating component 18 of this type thus constitutes an electrically heated catalyst (EHC).

The stabilization part 24 may have an electrically conductive coating or be made of an electrically conductive material, e.g., metal foam, and/or may comprise a catalytic material, for example be coated therewith. Accordingly, the stabilization part 24 may also constitute a resistance heating element and/or a catalyst.

The heating component 18 and the stabilization part 24 are made of a gas-permeable material to allow the exhaust gas to flow through the heating device 12.

As to the geometry and shape of the heating component 18 and the stabilization part 24, they are formed to be identical in the embodiment shown here, i.e., they are identical parts.

Here, the heating component 18 and the stabilization part 24 each have a disc shape and have an upstream oriented front end face 28 and 34, respectively, a downstream oriented rear end face 30 and 36, respectively, and an outer circumference 32 and 38, respectively.

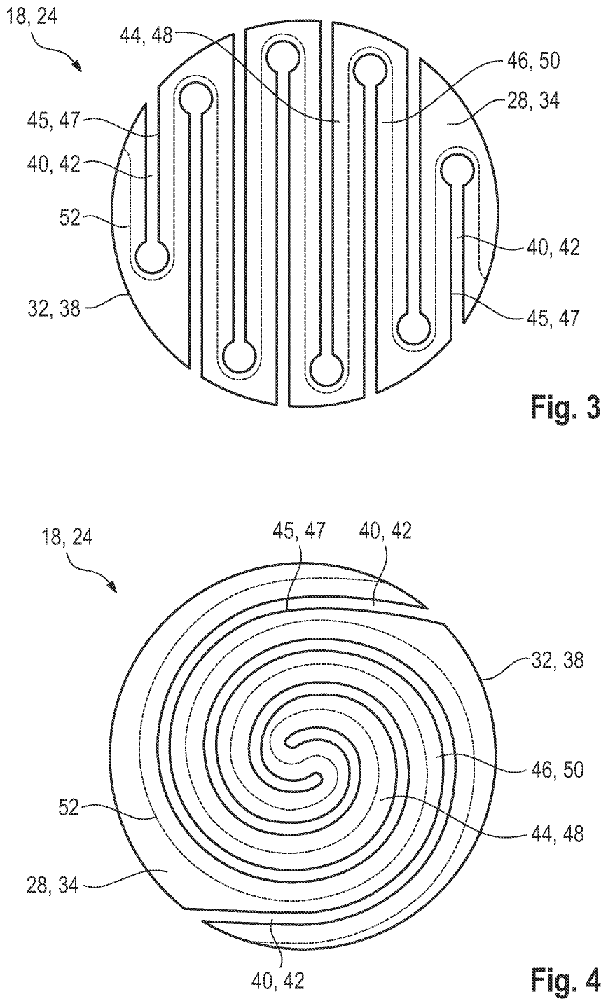

Preferably, the heating component 18 and the stabilization part 24 may be in the form of foamed parts. The foamed parts 18, 24 have a plurality of recesses 40 and 42, respectively, which are illustrated in greater detail in FIGS. 3 and 4.

FIG. 3 here shows a first variant embodiment of one of the foamed parts 18, 24.

The recesses 40 and 42 are defined by walls 45 and 47, respectively, and extend in the axial direction from the front end face 28 and 34, respectively, to the rear end face 30 and 36, respectively, through the foamed part 18 and 24, respectively, and, as viewed in the axial direction, from the outer circumference 32 and 38, respectively, in the variant embodiment illustrated here, in a straight line into the foamed part 18 and 24, respectively.

In this variant embodiment, the recesses 40 and 42 run parallel to each other, with neighboring recesses 40 and 42 beginning at substantially opposite portions of the outer circumference 32 and 38, respectively, and extending between neighboring recesses 40 and 42, respectively, which start from the opposite portion, like tines of rakes that engage each other.

Two opposing sections 44, 46 and 48, 50, respectively, are formed by each of the recesses 40 and 42, respectively, which are spaced apart from each other by the associated recess 40 and 42, respectively.

In other words, the recesses 40 and 42 terminate freely within the inner region 25, bounded by the outer circumference 32 and 38, respectively, of the foamed part 18 and 24, respectively.

In this way, the foamed part 18 and 24 is not divided into completely separate parts by the recesses 40 and 42, respectively.

The sections 44, 46 and 48, 50, respectively, thus continue into each other in the region of the free end of the recesses 40 and 42, respectively.

The recesses 40 and 42 define a shape of the foamed part 18 and 24, respectively, which predefines a specific current path 52 for the foamed part 18 coupled to the electrodes 20, 22—and also for the foamed part 24 if it is coupled to electrodes and has current flowing through it; the current path is illustrated in a simplified manner as a dashed line in FIGS. 3 and 4. Owing to the arrangement of the recesses 40 and 42 as shown here, the current path runs in a meandering or serpentine fashion.

Compared to a foamed part 18 or 24 without recesses 40 or 42, the current path 52 is significantly extended by the recesses 40 or 42, which results in a longer resistance heating element and thus in a more uniform and stronger heating of the foamed part 18 or 24.

FIG. 4 illustrates a second variant embodiment of one of the foamed parts 18 and 24, which essentially corresponds to the first variant embodiment shown in FIG. 3. Accordingly, only the differences will be discussed below, and identical and functionally identical parts are provided with the same reference numbers.

Rather than straight-line recesses 40 or 42, the foamed part 18 or 24 according to the second embodiment has recesses 40 or 42 that extend from the outer circumference 32 or 38 in a spiral pattern into a central region of the foamed part 18 or 24. Here, the recesses 40 or 42 start at substantially opposite portions of the outer circumference 32 or 38.

This provides a current path 52 that has two parts extending in the same direction and spirally with respect to each other, with the spirals running into each other.

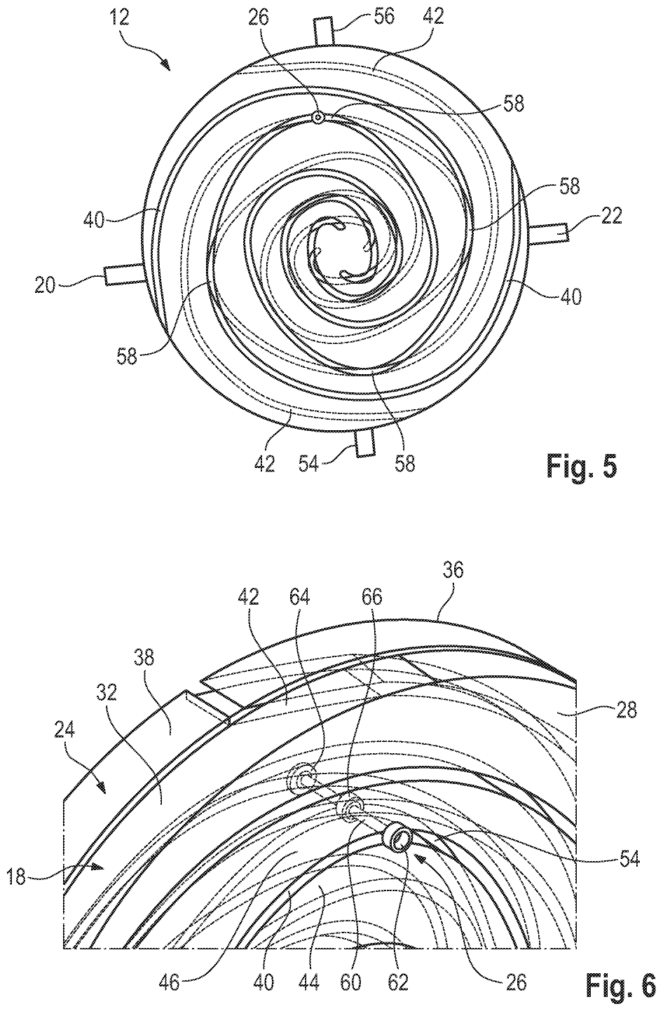

By reference to the variant embodiment of the foamed parts 18, 24 according to FIG. 4, a first method of coupling the two foamed parts 18, 24 by the coupling parts 26 will be discussed below with reference to FIGS. 5 and 6.

FIG. 5 shows the heating device 12 when viewed in the main flow direction 17, the first foamed part 18 being arranged upstream and thus in front of the second foamed part 24. For this reason, the recesses 42 of the second foamed part 24 are shown in dashed lines.

In the embodiment illustrated here, the second foamed part 24 is also connected to electrodes 54, 56, as is the first foamed part 18, and therefore also constitutes a resistance heating element.

The foamed parts 18, 24 are arranged so as to be offset from each other by an angle in the circumferential direction, so that the recesses 40, 42 are not completely superimposed.

The angle of the offset of the parts 18, 24 in the circumferential direction may, for example, be essentially 90°.

In this way, the recesses 40, 42 overlap only in sections in certain overlapping areas 58.

By way of example, one of the coupling parts 26 is arranged in only one overlapping area 58.

Of course, a coupling part 26 may also be arranged in a plurality of overlapping areas 58 or in all overlapping areas 58.

FIG. 6 shows the coupling part 26 in more detail in the installed state, with components concealed by the first foamed part 18 being shown in dashed lines, as in FIG. 5.

In accordance with the first coupling method illustrated here, the coupling part 26 extends through both foamed parts 18, 24, the coupling part 26 extending from the front end face 28 of the first foamed part 18 to the rear end face 36 of the second foamed part 24.

Here, the coupling part 26 comprises a pin 60 that includes a laterally projecting head part 62 at a first axial end and a laterally projecting counter piece 64 at a second end opposite to the first axial end. The pin 60 extends through both parts 18, 24.

The head part 62 and the counter piece 64 each bear against the associated end face 28, 36 of the foamed parts 18 and 24, respectively, with the two foamed parts 18, 24 being clamped therebetween.

The head part 62 and the counter piece 64 may be caps that are formed separately from the pin 60 and are pressed on the pin 60 by an interference fit and thereby secured thereto, or are fastened to the pin 60 by welding, soldering, gluing, screwing on or similar connection methods.

Furthermore, it may be provided that the head part 62 or the counter piece 64 integrally transitions into the pin 60, thereby forming a mushroom-shaped part.

A spacer 66 is disposed on the pin 60 between the two foamed parts 18, 24.

The spacer 66 may be formed as a spacer ring.

In addition, the spacer 66 may be pressed on the pin 60 by an interference fit and be thereby fixed thereto, or it may be fastened to the pin 60 by welding, soldering, gluing, screwing on, or similar connection methods.

As an alternative, the spacer 66 may be slid onto the pin 60 so as to be freely movable.

In the variant illustrated here, the coupling part 26 comprises electrically insulating material, for example ceramics, at least in the area of contact with the foamed parts 18, 24.

For this purpose, the coupling part 26 may be coated with or be comprised of the electrically insulating material.

It may also be provided that separate insulations, for example insulating rings, are arranged between the head part 62 and/or the counter piece 64 and the associated end faces 28 and 36, respectively, and between the spacer 66 and the associated end faces 30, 34.

In this way, an electrical bypass or an electrical short circuit between the sections 44, 46 or 48, 50 and between the foamed parts 18, 24 is avoided and thus the current path 52 specified by the recesses 40 or 42 of the foamed parts 18, 24 is maintained.

The coupling parts 26 are thus adapted to ensure that the sections 44, 46 or 48, 50 remain spaced apart from each other and do not contact each other even in the case of movements of the foamed parts 18, 24, for example caused by the gas flow or by vehicle vibrations.

The recesses 40, 42 cause the foamed parts 18, 24 to be relatively unstable and easily deformable, above all in the axial and/or radial direction, which may lead to damage and reduced service life under moving ambient conditions, e.g. vibrations in a travelling motor vehicle.

By the attachment of the foamed parts 18, 24 to each other, a relative movement, in particular an axial and/or radial relative movement, of the sections 44, 46 or 48, 50 can be prevented, which is caused, for example, by the gas flow or by vehicle vibrations. In this way, the axial and/or radial stiffness of the heating device 12 can be significantly increased.

In addition, the coupling parts 26 stabilize the sections 44, 46 or 48, 50 laterally in relation to each other because the recesses 40, 42 are bridged.

The coupling parts 26 therefore have a stabilization function in addition to the coupling function and, accordingly, also constitute stabilization parts.

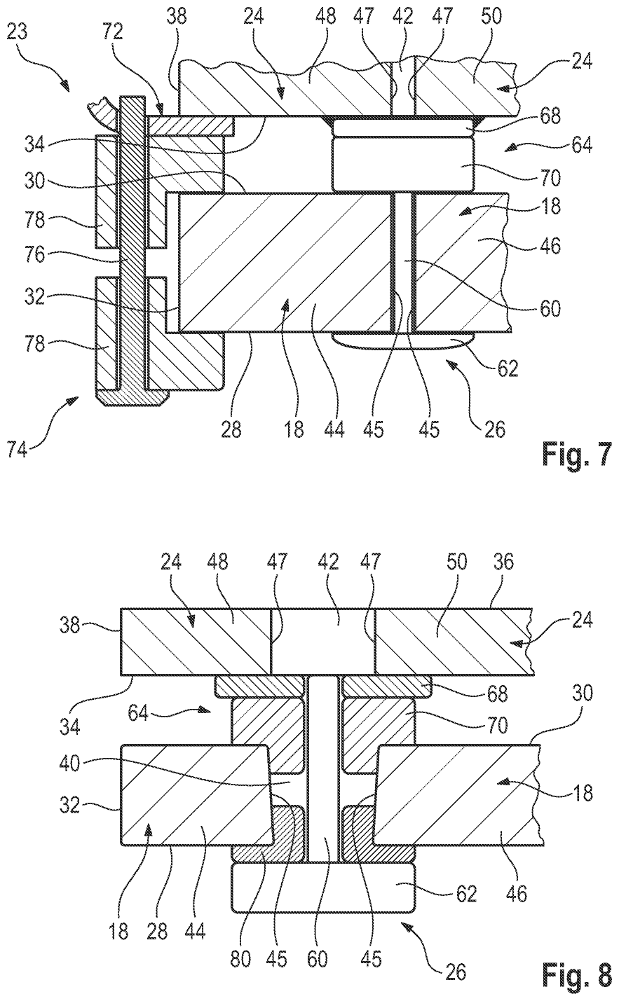

FIGS. 7 to 10 describe a second coupling method in which the pin 60 extends through only one of the two foamed parts 18, 24 and the other of the two foamed parts 18, 24 is fastened to the pin 60, the head part 62 and/or the counter piece 64.

Nonetheless, these remarks can be transferred to the first coupling method described in FIG. 6, which shows the coupling part 26 with the pin 60 extending through both foamed parts 18, 24. It is a matter of course that in this case the spacer 66, rather than the head part 62 or the counter piece 64, is arranged between the foamed parts 18, 24.

In the first variant embodiment, shown in FIG. 7, of the coupling part 26 of the second coupling method, the pin 60 integrally transitions into the head part 62, thereby forming a mushroom-like part having a free end at which the counter piece 64 is arranged in such a way that the foamed part 18 is clamped between the head part 62 and the counter piece 64.

The second foamed part 24 rests on the counter piece 64 and is fastened thereto, for example by welding, soldering, gluing or the like.

Here, the counter piece 64 extends from one section 48 laterally across the recess 42 to the other section 50 and is fastened to the sections 48, 50.

This means that the counter piece 64 serves as a spacer between the first foamed part 18 and the second foamed part 24.

Here, the head part 62 is arranged on the front end face 28 and the counter piece 64 is arranged on the rear end face 30 of the foamed part 18.

However, this is to be understood only as an example. The counter piece 64 (together with the second foamed part 24) may also be arranged on the front end face 28, and the head part 62 may be arranged on the rear end face 30 of the foamed part 18.

The head part 62 and the counter piece 64 form laterally projecting heads of the coupling part 26, between which the foamed part 18 is clamped and to one of which the second foamed part 24 is fastened.

In the variant shown, the counter piece 64 includes a cap 68 and an insulating ring 70 disposed between the cap 68 and the foamed part 18.

The insulating ring 70 comprises an electrically insulating material, for example ceramics, at least in the area of contact with the foamed part 18 and the cap 68.

To this end, the insulating ring 70 may be coated with or be comprised of the electrically insulating material.

In this case, the cap 68 may be of an electrically conductive material since the cap 68 and the foamed part 18 are spaced apart from each other by the insulating ring 70 and the foamed part 18 is electrically insulated from the cap 68.

Since the pin 60 and the head part 62 are also electrically insulated from the foamed part 18, no current can flow through the pin 60 and the counter piece 64 to the second foamed part 24.

An electrical insulation should nevertheless be provided between the cap 68 and the second foamed part 24 to prevent short circuit currents between the sections 48, 50.

Of course, the counter piece 64 may also be formed in one piece and be coated with or be comprised of the electrically insulating material.

For example, the cap 68 may be pushed onto the pin 60 with an interference fit and fixed, clamping the insulating ring 70 between itself and the foamed part 18.

Other fastening methods, such as, e.g., welding, gluing, soldering, bolting or the like, are also conceivable.

Owing to the clamping of the foamed part 18 between the head part 62 and the counter piece 64, the adjacent sections 44, 46 of the first foamed part 18 are mechanically coupled to each other, as a result of which the lateral stiffness of the first foamed part 18 can be increased and thus the stability can be improved.

The same applies to the sections 48, 50 of the second foamed part 24, since the counter piece 64 extends from one section 48 across the recess 42 to the other section 50 and is fastened to the sections 48, 50.

In this case, too, the coupling parts 26 have a stabilizing function in addition to the coupling function, and therefore also constitute stabilization parts.

In the embodiment illustrated here, for further fastening of the second foamed part 24 to the exhaust pipe, a holder 23 is provided in addition to the coupling part 26, the holder having, among other things, a support frame 72 arranged on the rear end face 30.

The support frame 72 may, of course, also be arranged on the front end face 28.

Here, the support frame 72 engages the foamed part 18 by a plurality of fastening devices 74 resting against the outer circumferential surface of the foamed part 18.

Each fastening device 74 comprises a plurality of parts coupled to each other, namely a fastening pin 76 and two clamping parts 78, all of which are part of the holder 23.

One of the clamping parts 78 rests against the front end face 28 of the foamed part 18 and the other of the clamping parts 78 rests against the rear end face 30, so that the foamed part 18 is clamped between the two clamping parts 78.

The clamping force is generated by the fastening pin 76, which extends through the clamping parts 78 laterally of the outer circumference 32 in the axial direction and is, for example, screwed into the support frame 72, urging the clamping parts 78 against the foamed part 18 and the support frame 72.

In the variant illustrated here, the clamping parts 78 comprise an electrically insulating material, for example ceramics, at least in the area of contact with the foamed part 18, the support frame 72 and the fastening pin 76.

To this end, the clamping parts 78 may be coated with or be comprised of the electrically insulating material.

In this case, the support frame 72 and the fastening pin 76 may be made of an electrically conductive material, since the fastening pin 76 and the support frame 72 are spaced apart from the foamed part 18 by the clamping parts 78, and the foamed part 18 is electrically insulated from the support frame 72 and the fastening pin 76.

Here, an electrical insulation should be provided between the support frame 72 and the second foamed part 24 to avoid short circuit currents between the sections 48, 50.

A holder 23 as described above may be provided for the second foamed part 24 as well. Alternatively, the second foamed part 24 is connected only to the first foamed part 18 via the coupling parts 26, so that the two foamed parts stabilize each other as in a layered structure.

In a different case, in which the fastening pin 76 and the support frame 72 comprise electrically insulating material at least in the area of contact with the foamed part 18, the fastening pin 76 may also extend through the foamed part 18 and be fastened to the support frame 72, which rests directly on or against one of the end faces 28, 30 of the foamed part 18.

A support frame 72 made of an electrically insulating material could, of course, also be attached directly to the foamed part 18 in some other way, for example by welding, gluing, soldering or the like.

The support frame 72 is merely optional.

FIGS. 8 to 10 show further variants of the coupling part 26 of the second coupling method, which are substantially the same as the first variant as shown in FIG. 7. Accordingly, only the differences will be discussed below, and identical and functionally identical parts are indicated by the same reference numbers.

In the second variant of the coupling part 26 of the second coupling method according to FIG. 8, the insulating ring 70 of the counter piece 64 has an extension that extends axially into the recess 40, thus providing a distance between the pin 60 and the walls 45 of the recess 40 in addition to the distance between the cap 68 and the associated end face 30.

In addition, a second insulating ring 80 is provided, which substantially corresponds to the insulating ring 70 and is disposed at the head part 62 to provide a distance between the head part 62 and the associated end face 28 and also between the pin 60 and the walls 45 of the recess 40.

Here, the pin 60 extends through the insulating rings 70, 80, the first foamed part 18 and the counter piece 64 as far as to the recess 42 of the second foamed part 24.

In this case, the pin 60 and the cap 68 may be comprised of an electrically conductive material since the pin 60 and the cap 68 are spaced apart from the foamed part 18 by the insulating rings 70, 80, and the foamed part 18 is electrically insulated from the pin 60 and the cap 68.

This also prevents current from flowing through the pin 60 and the counter piece 64 to the second foamed part 24.

Here, an electrical insulation should nonetheless be provided between the cap 68 and the second foamed part 24 to avoid short circuit currents between the sections 48, 50.

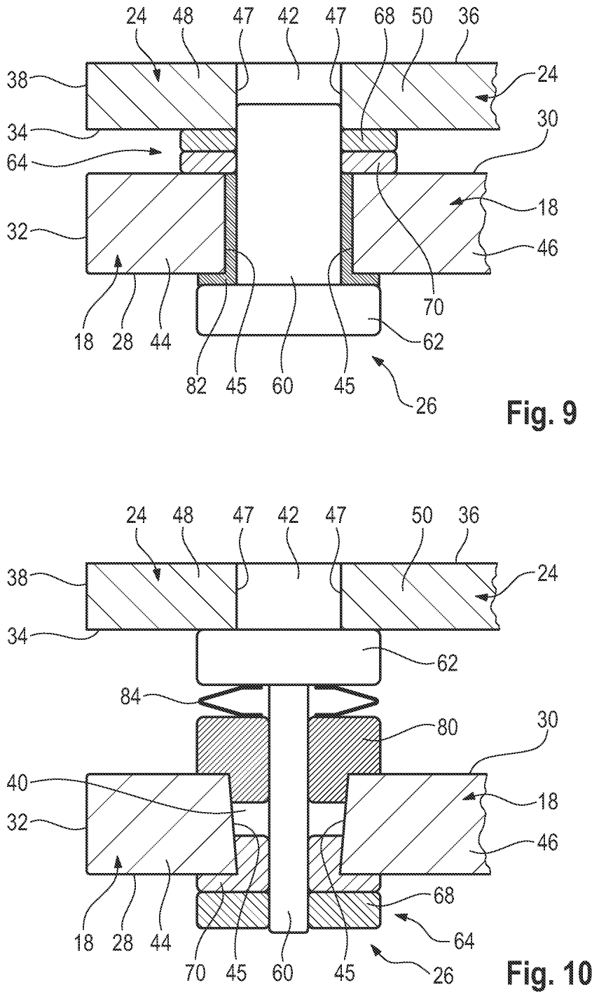

A third variant of the coupling part 26 according to FIG. 9 is very similar to the first variant according to FIG. 7.

However, the electrical insulation between the pin 60 and the foamed part 18 and also between the head part 62 and the foamed part 18 is not provided by the pin 60 and the head part 62 including an electrically insulating coating or being made of an electrically insulating material, but by a separate insulating sleeve 82 having a collar and extending over the entire potential contact area between the pin 60 and the foamed part 18 and also between the head part 62 and the foamed part 18.

A further difference from the first variant shown in FIG. 7 is that the pin 60 partly extends into the recess 42 of the second foamed part 24.

As a result, a lateral relative movement of the second foamed part 24 relative to the first foamed part 18 can be prevented, and, moreover, the distance between the two sections 48, 50 can be more reliably maintained.

Optionally, a simpler connection between the coupling part 26 and the second foamed part 24 can be achieved in that the second foamed part 24 is fastened to the coupling part 26 by connecting, for example welding, soldering, gluing or the like, the walls 47 to the pin 60. In this context, the connection point is easily reached through the recess 42.

In the variant shown, provision should be made for an electrical insulation between the cap 68 and the second foamed part 24 and between the pin 60 and the second foamed part 24, in order to avoid short circuit currents between the sections 48, 50.

It is also conceivable that, in the other variants of the coupling part 26, the pin 60 extends into the recess 42 of the second foamed part 24.

A fourth variant of the coupling part 26 of the second coupling method according to FIG. 10 is very similar to the second variant according to FIG. 8.

Here, however, the second foamed part 24 is attached to the head part 62 of the coupling part 26, and a spring element 84 (e.g., disk springs) is provided between the head part 62 and the second insulating ring 80 and is biased to push the head part 62 away from the second insulating ring 80. In this manner, the second insulating ring 80 is spring biased against the foamed part 18, and the first insulating ring 70 is spring biased against the foamed part 18 via the cap 68.

This allows, for example, any manufacturing-related gaps or distances between the coupling part 26 and the foamed part 18 to be compensated, as a result of which movements and attendant noises can be eliminated.

The positioning of the spring element 84 between the head part 62 and the second insulating ring 80 is to be understood to be merely exemplary. Provision may of course also be made for the spring element 84 to be arranged between the cap 68 and the first insulating ring 70.

It is also conceivable that the spring element 84 is employed in the first variant according to FIG. 7 or the third variant according to FIG. 9.

Furthermore, it is possible to manufacture the spring element 84 from an electrically insulating material. In this way, the spring element 84 can directly engage an end face 28, 30 of the foamed part 18, thereby eliminating the need for the second insulating ring 80 or the first insulating ring 70.

Of course, it is also possible in the other variants of the coupling part 26 for the second foamed part 24 to be fastened to the head part 62 of the coupling part 26, rather than to the counter piece 64.

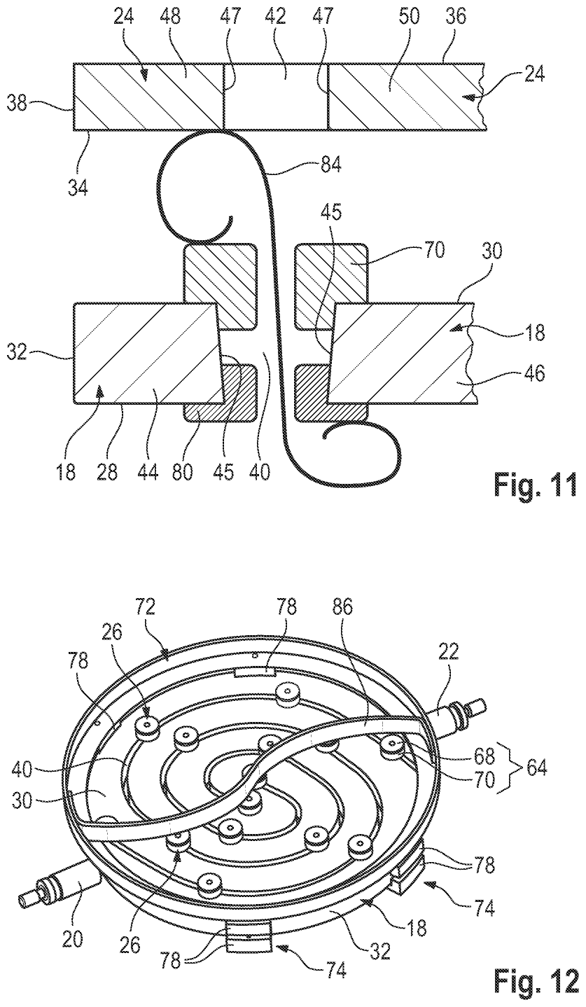

A fifth variant of the coupling part 26 of the second connecting method is shown in FIG. 11. In terms of its technical effect, the coupling part 26 shown here is very similar to the coupling part 26 shown in FIG. 10.

Instead of a pin 60, a head part 62 and a counter piece 64, only the spring element 84 is provided here, which extends from one of the end faces 28, 30 through the recess 40 and to the other of the end faces 28, 30, urging the first insulating ring 70 and the second insulating ring 80 against the foamed part 18.

The second foamed part 24 is attached in a front region of the spring element 84 here, for example by welding, soldering, gluing or the like.

In the embodiment shown, however, no common fastening of the two sections 48, 50 is affected here.

In a different embodiment, however, the spring element 84 may be shaped such that both sections 48, 50 are fastened in a front region of the spring element 84. In this case, the spring element 84 may be formed to be electrically conductive; however, in this case, an electrical insulation should be provided between the spring element 84 and the second foamed part 24.

Rather than one of the insulating rings 70, 80, the insulating sleeve 82, as in the third variant according to FIG. 9, may of course also be made use of.

Furthermore, the spring element 84 may be manufactured from an electrically insulating material. This allows the spring element 84 to directly engage the end faces 28, 30 of the foamed part 18, thereby eliminating the need for the insulating rings 70, 80. In this regard, the spring element 84 may then also be shaped such that both sections 48, 50 are fixed to the spring element 84 since no short circuit currents can occur between the sections 48, 50.

The spring element 84 may also be used in the first coupling method according to FIG. 6, in that the spring element 84, by analogy with the embodiment according to FIG. 11, extends through the recesses 40, 42 of the two foamed parts 18, 24, the spacer 66 being arranged on the spring element 84 between the foamed parts 18, 24.

In the case of a spring element 84 made of an electrically insulating material, the spring element 84 may be shaped between the foamed parts 18, 24 themselves such that it rests against the end faces 30, 34 at the same time while keeping the two foamed parts 18, 24 at a distance.

FIG. 12 illustrates an embodiment of the heating device 12 which constitutes a disclosure of its own and essentially corresponds to the embodiment of the heating device 12 according to FIG. 7. Accordingly, only the differences will be discussed below, and identical and functionally identical parts are designated with the same reference numbers.

In contrast to the embodiment of the heating device 12 according to FIG. 7, in the embodiment illustrated here, provision is not made for a second foamed part 24 for stabilizing the first foamed part 18, but rather for an inherently stiff and deformable stabilization element 86.

The stabilization element 86 extends transversely across the first foamed part 18 and is fastened to substantially diametrically opposed portions of the support frame 72.

The stabilization element 86 is formed of a deformable material, for example of metal, and is of a band-like configuration.

Furthermore, the stabilization element 86 here has an S-shape, which allows a buffer effect to be achieved that acts in the radial direction. In this way, for example, temperature-related deformations of the support frame 72 can be absorbed and buffered.

To stabilize the first foamed part 18, the stabilization element 86 is mechanically coupled to a number of coupling parts 26, over which the stabilization element 86 extends.

The remaining coupling parts 26 are not coupled to the support frame 72 or the stabilization element 86 and accordingly have a pure stabilization function of the sections 44, 46 if no second foamed part 24 is attached thereto.

It may be provided that the second foamed part 24 is attached to the support frame 72 and/or the coupling parts 26 in addition to the stabilization element 86.

Although various embodiments have been disclosed, a worker of ordinary skill in this art would recognize that certain modifications would come within the scope of this disclosure. For that reason, the following claims should be studied to determine the true scope and content of this disclosure.

1. A heating device for an exhaust system, comprising:
an electrically conductive heating component which is coupled to at least one electrode and is attached at an outer circumference to a duct wall-side holder and is oriented transversely to an exhaust gas stream and through which exhaust gas to be treated can flow in an axial flow direction in an inner region delimited by the duct wall-side holder and includes an upstream-oriented front end face and a downstream-oriented rear end face and is formed by one or more current-carrying lines forming a current path in a form of a resistance heating element between the at least one electrode and a further electrically conductive part to which the electrically conductive heating component is coupled; and
at least one stabilization part which extends inwardly of the duct wall-side holder over at least a portion of the inner region of the electrically conductive heating component and is arranged to be offset in relation to the electrically conductive heating component in the axial flow direction and is mechanically coupled in the inner region to the electrically conductive heating component in order to stabilize the electrically conductive heating component in the flow direction.

2. The heating device according to claim 1, wherein the electrically conductive heating component and the at least one stabilization part are electrically insulated from each other in a region in which the electrically conductive heating component and the at least one stabilization part are mechanically coupled to each other.

3. The heating device according to claim 1, including at least one coupling part which couples the electrically conductive heating component and the at least one stabilization part mechanically to each other in the inner region.

4. The heating device according to claim 1, wherein the electrically conductive heating component is a first foamed part which has at least one recess starting from the outer circumference and extending through the first foamed part in the axial flow direction from the upstream-oriented front end face to the downstream-oriented rear end face, so that sections of the first foamed part are produced by the at least one recess, which continue into each other and form the current path as the resistance heating element between the at least one electrode and the further electrically conductive part to which the first foamed part is coupled, and the at least one stabilization part is a second foamed part.

5. The heating device according to claim 4, wherein at least one coupling part extends through the at least one recess to the second foamed part and is fastened thereto.

6. The heating device according to claim 4, wherein at least one coupling part includes a pin which extends through at least one of the first and second foamed parts and is surrounded by an electrical insulation on an outside.

7. The heating device according to claim 6, wherein the electrical insulation is a sleeve surrounding the pin or a ring surrounding the pin, the sleeve or the ring contacting the at least one of the first and second foamed parts and holding the at least one of the first and second foamed parts away from the pin.

8. The heating device according to claim 7, wherein the sleeve or the ring, biased in a longitudinal direction of the pin, is pressed against the at least one of the first and second foamed parts through which the pin extends.

9. The heating device according to claim 4, wherein, in an axial view, the at least one recess extends between the sections in a straight line and/or in a curved manner

10. The heating device according to claim 4, wherein the current path extends in a spiral shape or a meandering shape.

11. The heating device according to claim 4, wherein the second foamed part has a same geometry as the first foamed part and, viewed in the axial flow direction, is installed to be offset by an angle in a circumferential direction in relation to the first foamed part, so that recesses of the first and second foamed parts do not completely coincide.

12. The heating device according to claim 11, wherein the recesses of the first and second foamed parts only overlap each other in sections.

13. The heating device according to claim 12, wherein at least one coupling part is provided in an overlapping area of the recesses.

14. The heating device according to claim 1, wherein at least one of the electrically conductive heating component and the at least one stabilization part is one of a resistance heating element and a catalyst.
